(19) United States
(12) Patent Application Publication
(10) Pub. No.: US 2023/0394306 A1
(43) Pub. Date: Dec. 7, 2023

(54) Multi-Modal Machine Learning Models with Improved Computational Efficiency Via Adaptive Tokenization and Fusion

(71) Applicant: Google LLC, Mountain View, CA (US)

(72) Inventors: Anthony J. Piergiovanni, Denver, CO (US); Wei-Cheng Kuo, Santa Clara, CA (US); Anelia Angelova, Palo Alto, CA (US)

(21) Appl. No.: 18/328,464

(22) Filed: Jun. 2, 2023

Related U.S. Application Data
(60) Provisional application No. 63/348,410, filed on Jun. 2, 2022.

(51) Int. Cl. G06N 3/08; G06N 3/0464; G06N 3/048; G06N 3/0455

(52) U.S. Cl. CPC G06N 3/08; G06N 3/0464; G06N 3/048; G06N 3/0455

(57) ABSTRACT

Provided is an efficient multi-modal processing model. The multi-modal processing model can process input data from multiple different domains to generate a prediction for a multi-modal processing task. A machine-learned multi-modal processing model can include an adaptive tokenization layer that is configured to adaptively tokenize features generated from the multi-modal inputs into sets of tokens. Specifically, the tokens may have a smaller data size relative to the features from the inputs, thereby enabling a reduced number of processing operations to be performed overall, thereby improving the efficiency of model.

### FIELD

The present disclosure relates generally to machine learning. More particularly, the present disclosure relates to a novel and efficient multi-modal learning model for multi-task multi-modal tasks.

### BACKGROUND

Multi-modal processing includes a number of challenging tasks that require a learning system to jointly process input data from multiple different modalities, such as, for example, input data that includes both images and language-based representations (e.g., natural language expressed as text). Multi-modal processing is challenging due the requirement for the learning system to comprehend and combine data from different modalities, which are often expressed using different representations and/or different feature dimensions.

As examples of a multi-modal tasks, multi-modal image-language learning is important for tasks such as Visual Question Answering (VQA), visual commonsense reasoning, visual grounding and referring expressions comprehension, visual captioning, cross-modality retrieval (e.g., image-to-text retrieval and/or and text-to-image retrieval), and others.

In particular, VQA tasks require understanding of both the content of the image, the language input, and the interactions between the image and language content. Previous approaches have addressed the VQA problem, where the most common strategy is to extract features from both image and text modalities and feed them to a Transformer architecture. This has been an effective learning approach across modalities. However, its main disadvantage is the lack of computational efficiency and scalability. Particularly, with current approaches, only modest image sizes can be used, and, when scaling the image size or the model components, the models become prohibitively large and computationally expensive.

Thus, efficient multi-modal models (e.g., Transformer-based models) which still adequately capture the interactions between input content from different modalities can allow for much wider applicability and are desired in the art.

### SUMMARY

Aspects and advantages of embodiments of the present disclosure will be set forth in part in the following description, or can be learned from the description, or can be learned through practice of the embodiments.

One example aspect is directed to a computing system for performing multi-modal processing with improved efficiency. The computing system includes one or more processors and one or more non-transitory computer-readable media. The media collectively store a machine-learned multi-modal processing model. The machine-learned multi-modal processing model includes: an adaptive tokenization layer configured to: adaptively tokenize a first set of features associated with a first input from a first domain to generate a first set of tokens; and adaptively tokenize a second set of features associated with a second input from a second domain to generate a second set of tokens, the second domain being different from the first domain. The machine-learned multi-modal processing model is configured to generate a prediction for a multi-modal processing task based at least in part on the first set of tokens and the second set of tokens. The media store instructions that, when executed by the one or more processors, cause the computing system to: process the first input and the second input with the machine-learned multi-modal processing model to generate the prediction; and provide the prediction as an output.

In some implementations, the first set of tokens has a smaller data size relative to the first set of features, and wherein the second set of tokens has a smaller data size relative to the second set of features.

In some implementations, to adaptively tokenize the first set of features associated with the first input from the first domain to generate the first set of tokens, the adaptive tokenization layer is configured to: apply one or more first convolutional layers having a first number of channels to the first set of features to generate a first intermediate output; perform a first softmax operation on the first intermediate output to generate a first set of attention maps; and apply the first set of attention maps to the first set of features to generate the first set of tokens, the first set of tokens consisting of a first number of tokens equal to the first number of channels.

In some implementations, to adaptively tokenize the second set of features associated with the second input from the second domain to generate the second set of tokens, the adaptive tokenization layer is configured to: apply one or more second convolutional layers having a second number of channels to the second set of features to generate a second intermediate output; perform a second softmax operation on the second intermediate output to generate a second set of attention maps; and apply the second set of attention maps to the second set of features to generate the second set of tokens, the second set of tokens consisting of a second number of tokens equal to the second number of channels.

In some implementations, to apply the first set of attention maps to the first set of features to generate the first set of tokens, the adaptive tokenization layer is configured to: multiply the first set of attention maps and the first set of features to generate a first multiplied output; and perform a first pooling operation on the first multiplied output to generate the first set of tokens.

In some implementations, to apply the second set of attention maps to the second set of features to generate the second set of tokens, the adaptive tokenization layer is configured to: multiply the second set of attention maps and the second set of features to generate a second multiplied output; and perform a second pooling operation on the second multiplied output to generate the second set of tokens.

In some implementations, to generate the prediction for the multi-modal processing task based at least in part on the first set of tokens and the second set of tokens, the machine-learned multi-modal processing model is configured to: process each of the first set of tokens and the second set of tokens with a fully connected layer to generate intermediate outputs having matching feature dimensions; concatenate the intermediate outputs having matching the feature dimensions to generate concatenated intermediate outputs; and generate the prediction for the multi-modal processing task based at least in part on the concatenated intermediate outputs.

In some implementations, the adaptive tokenization layer comprises an adaptive tokenization and fusion layer configured to one or both of: generate the first set of tokens from the first set of features associated with the first input from the first domain based at least in part on the second set of features associated with the second input from the second domain; or generate the second set of tokens from the second set of features associated with the second input from the second domain based at least in part on the first set of features associated with the first input from the first domain.

In some implementations, to generate the first set of tokens from the first set of features associated with the first input from the first domain based at least in part on the second set of features associated with the second input from the second domain, the adaptive tokenization and fusion layer is configured to: reshape the second set of features to have a common feature shape with the first set of features; after reshaping the second set of features, apply one or more convolutional layers to the reshaped second set of features to generate an intermediate output; perform a softmax operation on the intermediate output to generate a set of attention maps; and apply the set of attention maps to the first set of features to generate the first set of tokens.

In some implementations, to generate the first set of tokens from the first set of features associated with the first input from the first domain based at least in part on the second set of features associated with the second input from the second domain, the adaptive tokenization and fusion layer is configured to: reshape the second set of features to have a common feature shape with the first set of features; perform global-average-pooling on the first set of features to generate a pooled first set of features; combine the reshaped second set of features and the pooled first set of features to generate a combined set of features; apply one or more convolutional layers to the combined set of features to generate an intermediate output; perform a softmax operation on the intermediate output to generate a set of attention maps; and apply the set of attention maps to the first set of features to generate the first set of tokens.

In some implementations, to generate the first set of tokens from the first set of features associated with the first input from the first domain based at least in part on the second set of features associated with the second input from the second domain, the adaptive tokenization and fusion layer is configured to: reshape the second set of features to have a common feature shape with the first set of features; combine the reshaped second set of features and the first set of features to generate a combined set of features; apply one or more convolutional layers to the combined set of features to generate an intermediate output; perform a softmax operation on the intermediate output to generate a set of attention maps; and apply the set of attention maps to the first set of features to generate the first set of tokens.

In some implementations, to generate the first set of tokens from the first set of features associated with the first input from the first domain based at least in part on the second set of features associated with the second input from the second domain, the adaptive tokenization and fusion layer is configured to: combine the first set of features and the second set of features to generate a combined set of features; apply one or more convolutional layers to the combined set of features to generate an intermediate output; perform a softmax operation on the intermediate output to generate a set of attention maps; and apply the set of attention maps to the first set of features to generate the first set of tokens.

In some implementations, to apply the set of attention maps to the first set of features to generate the first set of tokens, the adaptive tokenization and fusion layer is configured to: multiply the first set of attention maps and the first set of features to generate a first multiplied output; and perform a first pooling operation on the first multiplied output to generate the first set of tokens.

In some implementations, the machine-learned multi-modal processing model comprises a decoder configured to generate the prediction from the first set of tokens and the second set of tokens or data derived from the first set of tokens and the second set of tokens.

In some implementations, the decoder generates the prediction in the form of open-vocabulary generated text.

In some implementations, the decoder generates the prediction in the form of generative image data.

In some implementations, the first domain comprises a spatial domain and the second domain comprises a linear domain; or the first domain comprises a linear domain and the second domain comprises a spatial domain.

In some implementations, the first domain comprises an image domain and the second domain comprises a language domain; or the first domain comprises a language domain and the second domain comprises an image domain.

In some implementations, the first input or the second input comprises a single still image or a video comprising multiple image frames.

In some implementations, the multi-modal processing task comprises a Visual Question Answering task.

In some implementations, the machine-learned multi-modal processing model has been trained end-to-end via supervised learning.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of an example machine-learned multi-modal processing model according to example embodiments of the present disclosure.

FIG. 2 depicts a graphical diagram of an example fusion layer according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to a novel and efficient multi-modal processing model. The multi-modal processing model can process input data from multiple different domains to generate a prediction for a multi-modal processing task. As one example, the multiple different domains can include a spatial domain (e.g., a domain in which data extends in multiple dimensions such as an image domain, including still image(s) and/or video which may be two dimensional or three dimensional in nature). As another example, the multiple different domains can include domains that commonly have a linear format in which data typically extends in a single dimension. One example of such a linear-formatted domain is a language domain such as a natural language. As one example, data in a language domain can be expressed using text (e.g., which can easily be converted to text embeddings). Other domains can be processed by the proposed model as well, including tabular data, statistical data (e.g., expressed as a sequence of feature value(s)), audio data, etc.

According to an aspect of the present disclosure, a machine-learned multi-modal processing model can include an adaptive tokenization layer that is configured to adaptively tokenize features generated from the multi-modal inputs into sets of tokens. Specifically, the tokens may have a smaller data size relative to the features from the inputs, thereby enabling a reduced number of processing operations to be performed overall, thereby improving the efficiency of model and conserving computational resources such as processor cycles, memory space, network bandwidth, etc. Thus, the proposed models can learn to select a smaller number of important features from each modality and combine them in a more compact and accurate encoder.

According to another aspect of the present disclosure, in some implementations, the adaptive tokenization layer can be or include an adaptive tokenization and fusion layer. Specifically, the adaptive tokenization and fusion layer can be configured to use features from one or more (e.g., some or all) of the inputs/modalities to assist in selecting or otherwise generating the tokens for or from the features from the one or more of the other inputs/modalities. Thus, some implementations of the proposed approach allow the model to use features from both modalities to select the important features from each input.

The adaptive tokenization described above (e.g., which may include a fusion-based approach) greatly reduces the FLOPs and memory footprint of the model, making it very efficient. As an example, one example implementation of the present disclosure takes only 17-25 GFLOPs compared to 172 GFLOPs for a baseline model, which is a 7-10× speedup. Furthermore, the proposed model is able to scale gracefully to more than twice the input image size from 17 to 22 GFLOPs.

Importantly, the proposed approach can be applied to or provide high quality performance in a multi-task setting, working simultaneously on many different tasks, without fine-tuning on individual tasks. Multi-task models are advantageous as they produce a single model to solve many tasks, and are also known to be much more robust to overfitting to novel tasks. This is a more challenging setting as the model has to work well on all tasks simultaneously. The difficulty is due to possibly conflicting objectives of various tasks, e.g., some might require longer text outputs, some shorter specific answers. However, while the proposed approaches can provide high quality performance in multi-task settings, they are not limited to multi-task settings. For example, the same approaches can be used for other settings, such as, for example, pre-training using large data and then fine tuning to individual tasks.

According to another aspect, some example implementations of the proposed model can be both trained and evaluated in the open-vocabulary (e.g., generated text) or other generative setting (e.g., generated image data), which means that the output is generated, as opposed to matching pre-defined outputs. This is clearly a harder setting than prior work which may simply require the model to perform a classification task. At the same time, generative outputs (e.g., generative natural language outputs) are more practically relevant and are more desirable.

Furthermore, the proposed approach demonstrates successful and efficient fusion of spatial-like inputs (e.g., images) with linear ones (e.g., text). Some example implementations can be Transformer-based and similarly can incorporate more similar types of inputs. The proposed efficient adaptive fusion can more easily scale to incorporate much larger or more inputs: large images, long texts, more layers and representation dimensions, with reasonable compute constraints.

Example implementations of the proposed approach were evaluated on several types of visual question-answering tasks, for example, visual question answering (VQA 2.0, GQA), visual entailment (SNLI-VE), and visual question answering for the visually impaired (VizWiz). The proposed architecture applied to image-language fusion outperforms or is competitive with the state-of-the-art, and is able to scale very with well with inputs and model sizes too.

The systems and methods of the present disclosure provide a number of technical effects and benefits. As one example technical effect and benefit, the proposed approach can enable performance of a multi-modal task with improved efficiency, resulting in conservation of computational resources such as processor cycles, memory space, network bandwidth, etc. Specifically, a machine-learned multi-modal processing model can include an adaptive tokenization layer that is configured to adaptively tokenize features generated from the multi-modal inputs into sets of tokens. Specifically, the tokens may have a smaller data size relative to the features from the inputs, thereby enabling a reduced number of processing operations to be performed overall, thereby improving the efficiency of model and conserving computational resources such as processor cycles, memory space, network bandwidth, etc. This improved efficiency may be achieved all the while maintaining or even improving model performance (e.g., accuracy).

As another example technical effect and benefit, the proposed approach can enable improved performance of a computer system on a multi-modal task. For example, the proposed models demonstrate improved performance relative to current state of the art multi-task learning approaches. Thus, the proposed techniques can improve the performance of the computer itself on various multi-modal tasks.

With reference now to the Figures, example embodiments of the present disclosure will be discussed in further detail.

### Example Adaptive Multi-Modal Fusion Models

The proposed techniques can be applied to a number of different model architectures. In some examples, the model can include an encoder-decoder architecture, where an encoder encodes inputs from multiple modalities, and the decoder produces output in a certain modality. One example model of this type is an image-language fusion model that receives both image and text input and outputs free-form text. Although aspects of this description will refer to image and text inputs for consistency and ease of explication, the inputs can be of other modalities as well.

Example models proposed herein can learn the interaction of these modalities different efficiently. Some example implementations can include (1) an adaptive tokenization step where a handful of tokens are learned adaptively from the data of each modality and (2) a fusion step where the model adaptively fuses the tokens from both modalities. This fusion mechanism greatly reduces the compute cost of the model, making it easy to scale both the model and the inputs.

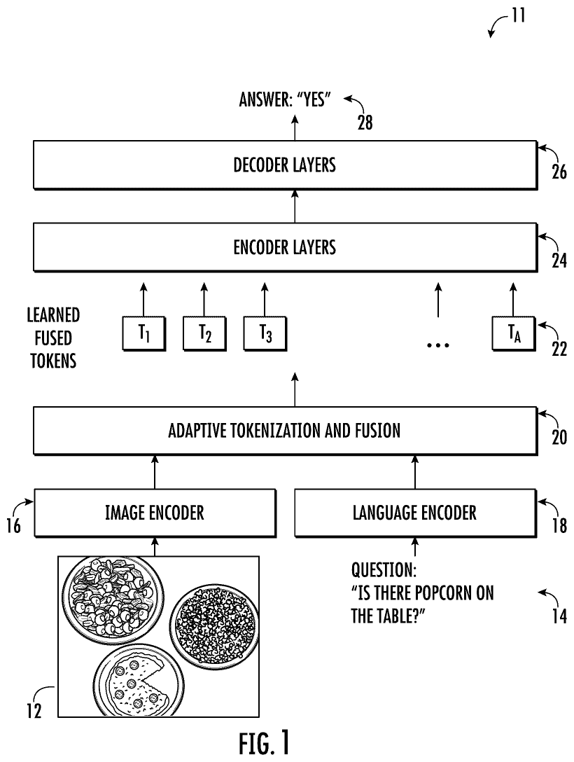

FIG. 1 depicts a graphical diagram of an example machine-learned multi-modal processing model 11 according to example embodiments of the present disclosure. The model 11 can receive two or more inputs of different modalities. For example, as illustrated, the model 11 can include an image input and a textual input 14. The model 11 can apply an image encoder 16 to the image input 12 to generate a set of image features. The model 11 can apply a language encoder 18 to the textual input 14 to generate a set of text features. The model 11 can include an adaptive tokenization and fusion layer 20 that processes the image features and the text features to generate a set of learned fused tokens 22. The set of learned fused tokens 22 are a limited number of tokens which jointly represent both modalities. The model 11 can include one or more encoder layers 24 and/or one or more decoder layers 26 that process the learned fused tokens 22 to generate an output 28 (e.g., a textual output).

Example Preliminaries. In some implementations, the input features (e.g., image and language features) are processed as follows. First backbone networks are applied to the image I and text T inputs, to produce image and text features: fᵢ=xᵢ(I), fₜ=xₜ(T), where xᵢ and xₜ are the image and text encoder networks. fᵢ has shape H×W>C, denoting the spatial size of the image feature map after the encoder. fₜ has shape L×D, with L the length of the text and D is the feature size after the text encoder. In some implementations, the image and text features are then fused together using concatenation and one or more further layers of a model (e.g., a model having a Transformer architecture) can be applied. In order to fuse these features, the feature dimensions can be matched, using a fully connected (FC)-layer. Then they can be reshaped and concatenated, along the sequence length dimension, e.g., L+H*W×D. This fused feature can be denoted as [fᵢ, fₜ]. The fused feature can then be passed through several self-attention transformer layers, and used as input to the text decoder.

While effective, this approach has a heavy computation and memory burden. For example, a standard 7×7 feature map from the image input and 128 length text sequence results in a sequence with length 177, which is then processed by each fusion transformer layer, and each decoder layer. Further, if the image is scaled up, this quadratically increases the sequence length and compute needed.

Instead, example implementations of the present disclosure can apply an approach that greatly reduces the number of needed tokens, saving FLOPs and memory.

### Example Adaptive Tokenization Layers

Instead of processing all the input features at all time, the present disclosure proposes an architecture that can learn to select the most important ones. The proposed approach performs an adaptive tokenization approach applied to both image and text inputs (or potentially other modalities in addition or alternatively to text and/or image).

This section first describes the mechanism for each modality separately, then describes the adaptive fusion.

Adaptive image tokenization: Some example implementations take the image features, fᵢ, and extract a fixed number, e.g., N, learnable tokens from the features. To do this, a proposed adaptive tokenization can apply a convolution layer to fᵢ with N channels (e.g., same as the desirable number of tokens), and apply a softmax to it, as follows: a=σ(w\textcircled{*}fᵢ).

Here a can be thought of as the attention map, and N is the number of tokens that the operation is extracting, and N<<H*W. The model can apply this attention map to the input features fᵢ as: fᵢ^{T}aᵢ. This generates a C dimensional feature, compressing the whole image into a single token. As a result, the model can generate N tokens, which results in a feature with shape N×C.

Adaptive text tokenization: This process can similarly be applied to text sequences, for example using 1D convolution instead of 2D over the input text feature representation to generate aₜ, resulting in M generated text tokens with shape M×D.

The number of tokens for each modality, denoted here as N and M for image and text, can be different in general, and in most cases for VQA, will be, as images have larger information content than text. The number of feature dimensions C and D for each modality might differ too, so in order to process them together, some example implementations can then apply a FC layer to make the feature dimensions match and concatenate the features. These can be passed through the rest of the network. Note that this mechanism is not limited to only these types of modalities, as noted elsewhere herein.

### Example Adaptive Fusion Layers

Adaptive tokenization can efficiently learn compact representation tokens, but still relies on the transformer layers to fuse the image and text features. Additional example implementations of the present disclosure can include and/or leverage an approach to adaptively fuse the image and text features together, allowing the tokenization step to use information from both streams. In particular, one or both modalities can affect the tokenization process. One change included in example implementations of this approach is that, instead of generating the attention map from only a single modality, the attention map can be generated using a combination of both features. However, image and text features have different shapes, so it is nontrivial to combine them.

Let us denote aᵢ and aₜ as the attention maps generated for the image and text, features, respectively. When each of the text and image modalities are tokenized separately, for brevity this description will use only the following operator \textcircled{*} to signify a selection of tokens per modality. It should be understood that a series of convolutions can in fact be applied to produce N masks per modality which are then multiplied by the original feature map and pooled to produce N tokens:

aᵢ=σ(wᵢ\textcircled{*}fᵢ), aₜ=σ(wᵢ\textcircled{*}fₜ) (1)

Text-to-image fusion (TTI): This section first describes examples of how the text features can affect the learned tokenization for the image features. In some implementations, only the text feature are used to generate aᵢand aₜ, and tokenize the image and text based on that feature map. Some example implementations can do this using a FC layer and then reshaping the text feature to have H×W×C features (which is denoted as w₁^{T}fₜ in Equation 2). The attention map can then be generated as described above. The text can be tokenized as before. Note that the image features are tokenized using only text inputs:

aᵢ=σ(wᵢ\textcircled{*}(w₁^{T}fₜ)), aₜ=σ(wₜ\textcircled{*}fₜ) (2)

Text-image fusion (TI): In this example setting, some example implementations use both the text and image features to affect the tokenization of text, and the images are tokenized from image features only. Unlike the previous version where tokenization is done within a modality, using both features to affect the tokenization is a more general approach. Some example implementations can apply global-average-pooling (GAP) to the image feature, concatenate it with the text feature (e.g., FC layer w₁ to match feature dimension) and use that as the feature to generate aₜ, for the text tokenization. For the image tokenization, some example implementations use the same as before:

aᵢ=σ(wᵢ\textcircled{*}fᵢ), aₜ=σ(wₜ\textcircled{*}[GAP(fᵢ), w₁^{T}fₜ]) (3)

Spatial fusion (SP): In another example setting, some example implementations can use both features together to affect tokenization, and here it can be done for tokenization on both modalities. To generate tokenization for images, instead of using GAP, as in the text-image method, some example implementations can generate a H×W×C feature map from the text, concatenate it with the image feature, then use that to generate aᵢ. aₜcan, for example, be generated as in text-image fusion described above.

aᵢ=σ(wᵢ\textcircled{*}[fᵢ, w₁^{T}fₜ])

aₜ=σ(wᵢ\textcircled{*}[GAP(fᵢ)w₂^{T}fₜ]) (4)

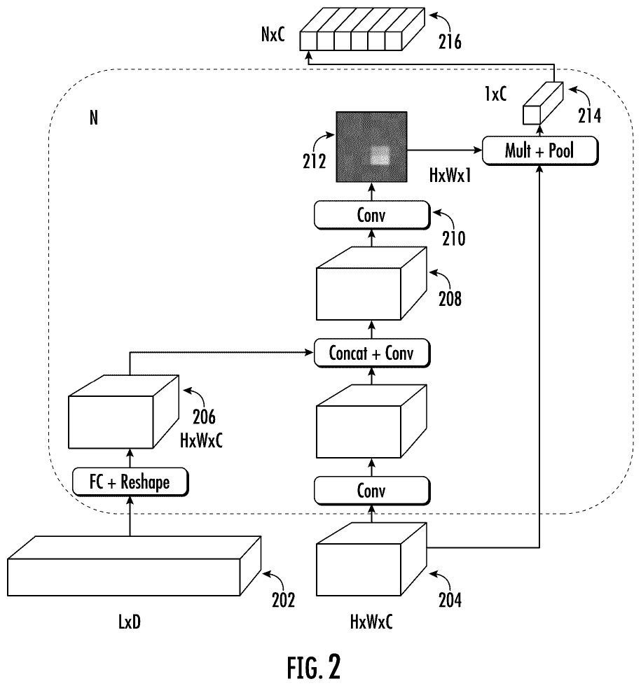

An example visualization of this approach is shown in FIG. 2. In FIG. 2, the fusion layer receives text features 202 and image features 204. The fusion layer reshapes the text features 202 to have a common feature shape with the image features 204, producing reshaped text features 206. The fusion layer combines the reshaped text features 206 and the images features 204 (e.g., which have been processed using convolutional operator(s)) to generate a combined set of features 208. The fusion layer applies one or more convolutional layers 210 to the combined set of features 208 to generate an intermediate output. The fusion layer performs a softmax operation on the intermediate output to generate an attention map 212. The fusion layer applies the attention map 212 to the image features 204 to generate a token 214. A number (N) of fusion layers can be applied in this manner (e.g., in parallel) to produce a set of tokens 216.

Position embeddings. When using the proposed tokenization method, the spatial positions are lost by the pooling, and the order of the tokens has no importance. To address this, some example implementations can use learned 2D position embeddings and add them to fᵢ before the pooling step. This ensures that each token has some position location in it.

Example implementation details. Some example implementations can have the following example details: The model is a standard Transformer encoder-decoder, where in order to process the modalities, a ResNet image backbone is used, and a T5 transformer is used for the text encoder and the decoder which produces the text output. The text input length is 32, the standard input image size is 224×224 (which is scaled to 480−480 thanks to the adaptive fusion). A small model can be trained with 12 encoder, fusion, and decoder layers, and a main model with 32.

### Example Devices and Systems

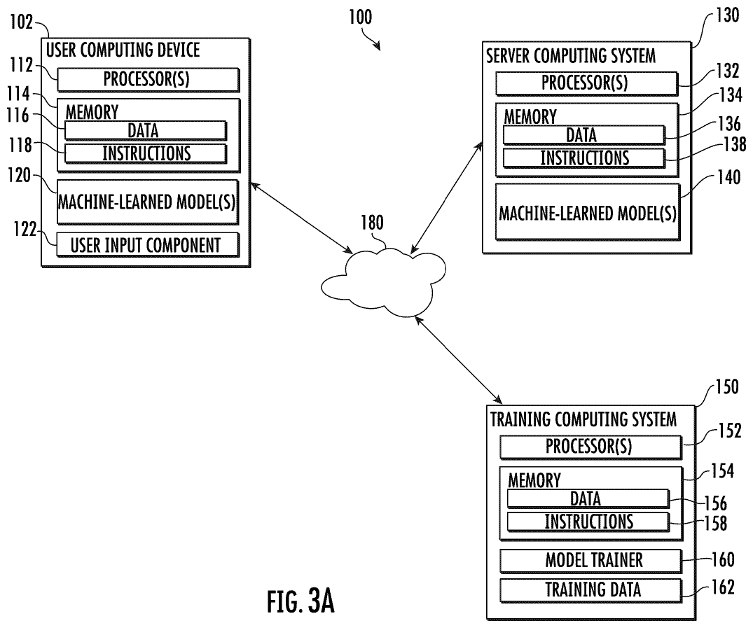

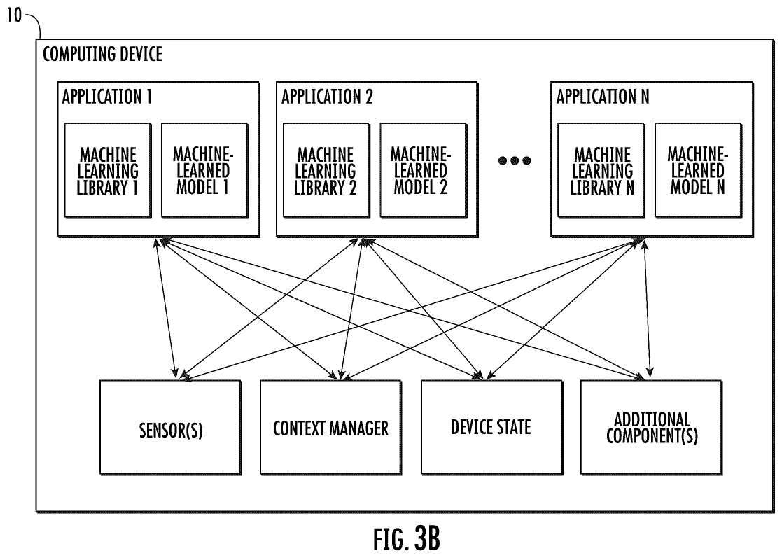

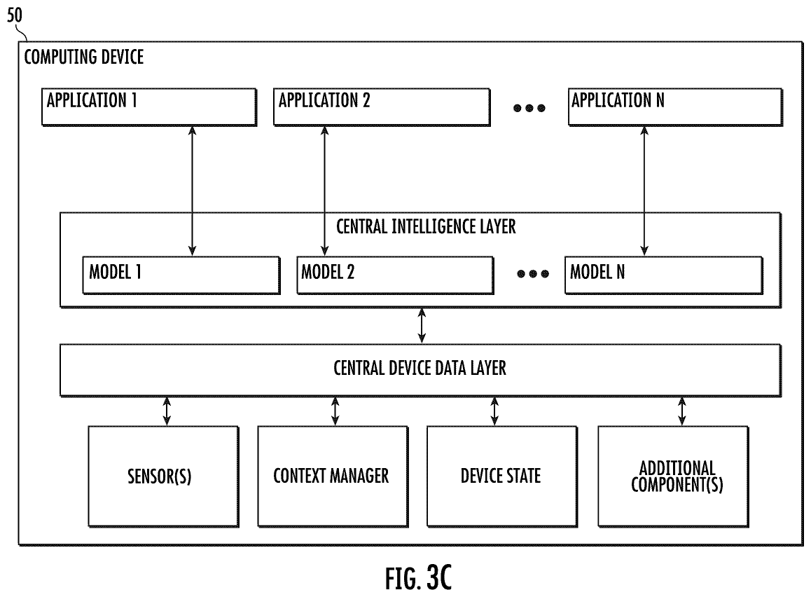

FIG. 3A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel processing across multiple instances of inputs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, supervised learning training examples having a pair consisting of: (a) one or more inputs; and (b) a ground truth label indicating a “correct” output for the model to produce when given the one or more inputs. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for performing multi-modal processing with improved efficiency, the computing system comprising:
one or more processors; and
one or more non-transitory computer-readable media that collectively store:
a machine-learned multi-modal processing model, the machine-learned multi-modal processing model comprising:
an adaptive tokenization layer configured to:
adaptively tokenize a first set of features associated with a first input from a first domain to generate a first set of tokens; and
adaptively tokenize a second set of features associated with a second input from a second domain to generate a second set of tokens, the second domain being different from the first domain; and
wherein the machine-learned multi-modal processing model is configured to generate a prediction for a multi-modal processing task based at least in part on the first set of tokens and the second set of tokens; and
instructions that, when executed by the one or more processors, cause the computing system to:
process the first input and the second input with the machine-learned multi-modal processing model to generate the prediction; and
provide the prediction as an output.

2. The computing system of claim 1, wherein the first set of tokens has a smaller data size relative to the first set of features, and wherein the second set of tokens has a smaller data size relative to the second set of features.

3. The computing system of claim 1, wherein:
to adaptively tokenize the first set of features associated with the first input from the first domain to generate the first set of tokens, the adaptive tokenization layer is configured to:
apply one or more first convolutional layers having a first number of channels to the first set of features to generate a first intermediate output;
perform a first softmax operation on the first intermediate output to generate a first set of attention maps; and
apply the first set of attention maps to the first set of features to generate the first set of tokens, the first set of tokens consisting of a first number of tokens equal to the first number of channels; and
to adaptively tokenize the second set of features associated with the second input from the second domain to generate the second set of tokens, the adaptive tokenization layer is configured to:
apply one or more second convolutional layers having a second number of channels to the second set of features to generate a second intermediate output;
perform a second softmax operation on the second intermediate output to generate a second set of attention maps; and
apply the second set of attention maps to the second set of features to generate the second set of tokens, the second set of tokens consisting of a second number of tokens equal to the second number of channels.

4. The computing system of claim 3, wherein:
to apply the first set of attention maps to the first set of features to generate the first set of tokens, the adaptive tokenization layer is configured to:
multiply the first set of attention maps and the first set of features to generate a first multiplied output; and
perform a first pooling operation on the first multiplied output to generate the first set of tokens; and
to apply the second set of attention maps to the second set of features to generate the second set of tokens, the adaptive tokenization layer is configured to:
multiply the second set of attention maps and the second set of features to generate a second multiplied output; and
perform a second pooling operation on the second multiplied output to generate the second set of tokens.

5. The computing system of claim 3, wherein to generate the prediction for the multi-modal processing task based at least in part on the first set of tokens and the second set of tokens, the machine-learned multi-modal processing model is configured to:
process each of the first set of tokens and the second set of tokens with a fully connected layer to generate intermediate outputs having matching feature dimensions;
concatenate the intermediate outputs having matching the feature dimensions to generate concatenated intermediate outputs; and
generate the prediction for the multi-modal processing task based at least in part on the concatenated intermediate outputs.

6. The computing system of claim 1, wherein:
the adaptive tokenization layer comprises an adaptive tokenization and fusion layer configured to one or both of:
generate the first set of tokens from the first set of features associated with the first input from the first domain based at least in part on the second set of features associated with the second input from the second domain; or
generate the second set of tokens from the second set of features associated with the second input from the second domain based at least in part on the first set of features associated with the first input from the first domain.

7. The computing system of claim 6, wherein to generate the first set of tokens from the first set of features associated with the first input from the first domain based at least in part on the second set of features associated with the second input from the second domain, the adaptive tokenization and fusion layer is configured to:
reshape the second set of features to have a common feature shape with the first set of features;
after reshaping the second set of features, apply one or more convolutional layers to the reshaped second set of features to generate an intermediate output;
perform a softmax operation on the intermediate output to generate a set of attention maps; and
apply the set of attention maps to the first set of features to generate the first set of tokens.

8. The computing system of claim 6, wherein to generate the first set of tokens from the first set of features associated with the first input from the first domain based at least in part on the second set of features associated with the second input from the second domain, the adaptive tokenization and fusion layer is configured to:
reshape the second set of features to have a common feature shape with the first set of features;
perform global-average-pooling on the first set of features to generate a pooled first set of features;
combine the reshaped second set of features and the pooled first set of features to generate a combined set of features;
apply one or more convolutional layers to the combined set of features to generate an intermediate output;
perform a softmax operation on the intermediate output to generate a set of attention maps; and
apply the set of attention maps to the first set of features to generate the first set of tokens.

9. The computing system of claim 6, wherein to generate the first set of tokens from the first set of features associated with the first input from the first domain based at least in part on the second set of features associated with the second input from the second domain, the adaptive tokenization and fusion layer is configured to:
reshape the second set of features to have a common feature shape with the first set of features;
combine the reshaped second set of features and the first set of features to generate a combined set of features;
apply one or more convolutional layers to the combined set of features to generate an intermediate output;
perform a softmax operation on the intermediate output to generate a set of attention maps; and
apply the set of attention maps to the first set of features to generate the first set of tokens.

10. The computing system of claim 6, wherein to generate the first set of tokens from the first set of features associated with the first input from the first domain based at least in part on the second set of features associated with the second input from the second domain, the adaptive tokenization and fusion layer is configured to:
combine the first set of features and the second set of features to generate a combined set of features;
apply one or more convolutional layers to the combined set of features to generate an intermediate output;
perform a softmax operation on the intermediate output to generate a set of attention maps; and
apply the set of attention maps to the first set of features to generate the first set of tokens.

11. The computing system of claim 7, wherein to apply the set of attention maps to the first set of features to generate the first set of tokens, the adaptive tokenization and fusion layer is configured to:
multiply the first set of attention maps and the first set of features to generate a first multiplied output; and
perform a first pooling operation on the first multiplied output to generate the first set of tokens.

12. The computing system of claim 1, wherein machine-learned multi-modal processing model comprises a decoder configured to generate the prediction from the first set of tokens and the second set of tokens or data derived from the first set of tokens and the second set of tokens.

13. The computing system of claim 12, wherein the decoder generates the prediction in the form of open-vocabulary generated text.

14. The computing system of claim 12, wherein the decoder generates the prediction in the form of generative image data.

15. The computing system of claim 1, wherein:
the first domain comprises a spatial domain and the second domain comprises a linear domain; or
the first domain comprises a linear domain and the second domain comprises a spatial domain.

16. The computing system of claim 1, wherein:
the first domain comprises an image domain and the second domain comprises a language domain; or
the first domain comprises a language domain and the second domain comprises an image domain.

17. The computing system of claim 1, wherein the first input or the second input comprises a single still image or a video comprising multiple image frames.

18. The computing system of claim 1, wherein the multi-modal processing task comprises a Visual Question Answering task.

19. The computing system of claim 1, wherein the machine-learned multi-modal processing model has been trained end-to-end via supervised learning.

20. One or more non-transitory computer-readable media that collectively store a machine-learned multi-modal processing model, the machine-learned multi-modal processing model comprising:
an adaptive tokenization layer configured to:
adaptively tokenize a first set of features associated with a first input from a first domain to generate a first set of tokens; and
adaptively tokenize a second set of features associated with a second input from a second domain to generate a second set of tokens, the second domain being different from the first domain; and
wherein the machine-learned multi-modal processing model is configured to generate a prediction for a multi-modal processing task based at least in part on the first set of tokens and the second set of tokens.
